(19) United States
(12) Patent Application Publication
(10) Pub. No.: US 2009/0279307 A1
(43) Pub. Date: Nov. 12, 2009

(54) ILLUMINATING UNIT WITH HIGH EFFICIENCY

(76) Inventor: Chih-Yuan CHUANG, Taipei Hsien (TW)

Correspondence Address: SINORICA, LLC, 2275 Research Blvd., Suite 500, ROCKVILLE, MD, 20850, US

(21) Appl. No.: 12/117,787

(22) Filed: May 9, 2008

(51) Int. Cl. F21V 7/00; F21V 11/00

(52) U.S. Cl. 362/310; 362/351

(57) ABSTRACT

The illuminating unit with high efficiency comprises mainly a light emitting element and a reflective lamp shade; the light emitting element has two elongate conductors of which part outer surface areas have insulation portions, the elongate conductors are connected with an electric power source to provide electricity for the light emitting element to enlighten; the inner surface of the reflective lamp shade forms a complete arched reflecting surface, it is provided on its wall with two through holes, each through hole is only extended therethrough by one of the conductors of the light emitting element, and the insulation portions of the conductors are fixed in the through holes; with the design of the reflective lamp shade, a larger area can be provided for reflecting light beams to the district to be illuminated. The illuminating unit of high efficiency provided in the present invention results relative reduction of light beam losing by increasing of reflective area.

### BACKGROUND OF THE INVENTION

1. Field of the Invention

The present invention relates to an illuminating unit; and especially to an illuminating unit with high efficiency, the illuminating unit can have the light beams of a light emitting element almost completely emitted through a reflective lamp shade.

2. Description of the Prior Art

A normal conventional illuminating unit, such as is shown in FIG. 1, is comprised basically of a reflective lamp shade 91, a light emitting element 92 and a connector 93.

The light emitting element 92, such as is a light emitting diode (LED), has a pair of conductors 921 used for connecting an electric power source to generate light energy, and the pair of conductors 921 do not have any electric insulation layer thereon.

The reflective lamp shade 91 is provided thereon with a through hole 911 forming a neck portion and being used for mounting an electric power source connector 93 for the light emitting element 92 to get electric power, the connector 93 extends through the reflective lamp shade 91.

The electric power source connector 93 which does not have the function of reflection is made of electric insulation material, it is provided therein with a pair of inner conductors 931 and with a pair of outer conductors 932 extending out of it; the connector 93 is integral with the reflective lamp shade 91. The main function of the connector 93 is for changing for a similar or a different light emitting element with the same connector but with different power when the light emitting element 92 is out of order. The light emitting element 92 gets electric power after it is inserted into the electric power source connector 93, and light can be emitted.

In the drawing, light beams S1, S2 and S3 indicate effective distribution of illumination of light; while light beams S4 and S5 will be refracted to the electric power source connector 93 after they are irradiated onto the reflective lamp shade 91. By the fact that the electric power source connector 93 does not have the function of reflection, the light beams S4 and S5 become null light; moreover, light beams S6 and S7 being irradiated onto the connector 93 are also null light.

Therefore, a conventional illuminating unit is unable to give maximum efficiency of illumination, the primary cause of this is undue design in structure; the illuminating unit makes most of light beams irradiate toward all directions. By such undue design, and it is required to have large brightness of illumination, people can not help increasing the power of a light emitting source to provide the required large brightness, and this results waste of energy source.

In view of the above, the largest defect of a conventional illuminating unit is that part of the light beams emitted from the light emitting element are unable to reach the areas to be illuminated and become null light; thus improvement is required.

Particularly, a conventional illuminating unit used presently can be developed toward the direction of having a spot light source that generate large brightness, such as an LED lamp bulb; although the light source of the LED lamp bulb is a spot light source, light beams can irradiate toward all directions; only a PCB core piece in the lamp shade of the LED lamp bulb can be a light source; if light irradiates directly or indirectly the PCB core piece, the light too is null light, and likewise some light beams generated in an area are null. Illuminating units of which light is most like sun light used recently are xenon head lights of cars, 35 W power of each xenon head light can generate 3200 Lm fluxes of light, while a conventional structure used could lose 400 Lm fluxes of light.

### SUMMARY OF THE INVENTION

The illuminating unit with high efficiency provided in the present invention mainly is to effectively reduce lose of light beams that can be resulted by a conventional illuminating unit, and to increase effective fluxes of light; in order that a light emitting element of lower power used can get the same brightness generated by a conventional structure of higher power, this can have benefit of saving energy.

The illuminating unit with high efficiency provided in the present invention comprises mainly a light emitting element and a reflective lamp shade; the light emitting element has two elongate conductors of which part outer surface areas have insulation portions, the elongate conductors are connected with an electric power source to provide electricity for the light emitting element to enlighten; the inner surface of the reflective lamp shade forms a complete arched reflecting surface, it is provided on its wall with two through holes, each through hole is only extended therethrough by one of the conductors of the light emitting element, and the insulation portions of the conductors are fixed in the through holes; with the design of the reflective lamp shade, a larger area can be provided for reflecting light beams to the district to be illuminated. The illuminating unit of high efficiency provided in the present invention results relative reduction of light beam losing.

As compared with the prior art, the illuminating unit of high efficiency provided in the present invention can make most of light beams that originally might be lost effective light beams; if 80% of lost light beams can become effective light beams, 320 Lm fluxes of increased effective light can be obtained, this is 10% of the fluxes of light generated. Therefore, with the design of the present invention, it can obtain 2800 Lm fluxes of light under merely 31 W power, while a conventional structure needs 35 W power to obtain such 2800 Lm fluxes of light, the present invention can thus save 11% of energy source. In view of this, the function of increasing the efficiency of illumination of the present invention is extremely excellent.

The present invention will be apparent in its structure and effects after reading the detailed description of the preferred embodiment thereof in reference to the accompanying drawings.

### BRIEF DESCRIPTION OF THE DRAWINGS

FIG. 1 is a schematic sectional view of a conventional illumination lamp;

FIG. 2 is an exploded perspective view showing a first embodiment of the present invention;

FIG. 3 is a schematic sectional view after assembling of the first embodiment of the present invention;

FIG. 4 is an exploded perspective view showing a second embodiment of the present invention;

FIG. 5 is a schematic sectional view after assembling of the second embodiment of the present invention;

FIG. 6 is an exploded perspective view showing a third embodiment of the present invention;

FIG. 7 is a schematic sectional view after assembling of the third embodiment of the present invention;

FIG. 8 is an exploded perspective view showing a fourth embodiment of the present invention;

FIG. 9 is a schematic sectional view after assembling of the fourth embodiment of the present invention;

FIG. 10 is an exploded perspective view showing a fifth embodiment of the present invention;

FIG. 11 is schematic sectional view after assembling of the fifth embodiment of the present invention.

### DETAILED DESCRIPTION OF THE PREFERRED EMBODIMENT

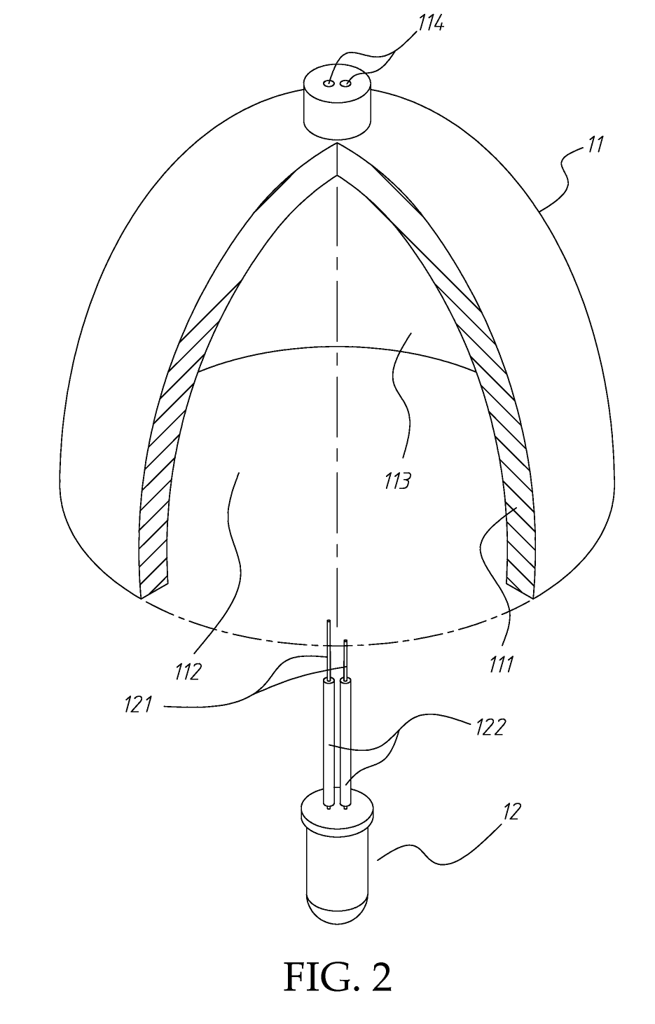

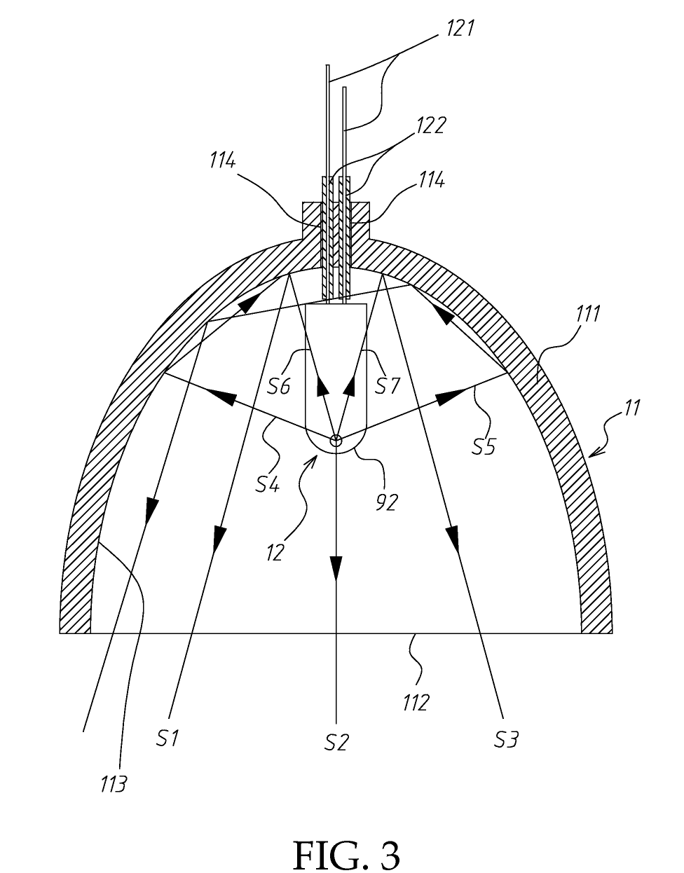

Referring firstly to FIGS. 2 and 3, which shows a first embodiment of an illuminating unit with high efficiency of the present invention, the illuminating unit comprises mainly a light emitting element 12 and a reflective lamp shade 11.

The light emitting element 12 has two elongate conductors 121 of which part outer surface areas have insulation portions 122. The insulation portions 122 can be insulating sleeves or can be painted with insulation paint; and the elongate conductors 121 are connected with an electric power source to provide electricity for the light emitting element 12 to enlighten.

The reflective lamp shade 11 has a wall 111 encircling a hollow space which forms a light projecting out opening 112 and then extends upwards till a closed top, so that the inner surface of the wall 111 forms a complete arched reflecting surface, the wall is provided thereon with two through holes 114, each through hole 114 is only extended therethrough by one of the conductors 121 of the light emitting element 12, and the insulation portions 122 of the conductors 121 are fixed in the through holes 114, such as is shown in FIG. 3.

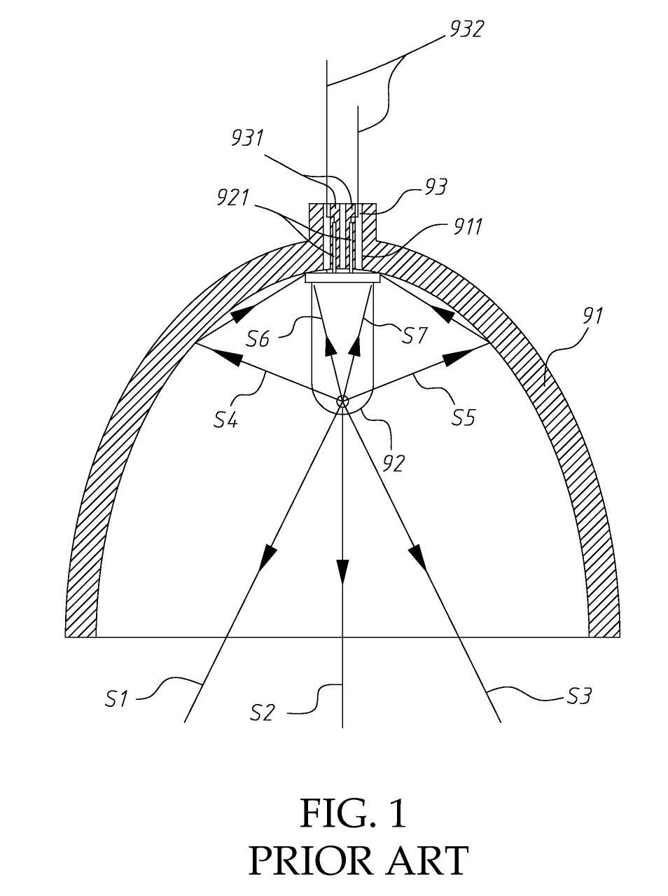

As depicted in FIG. 3, the light emitting element 12 is placed in the reflective lamp shade 11; when light beams S4, S5, S6 and S7 after electric power is given irradiate the reflective surfaces, they are refracted for several times and irradiate the district to be illuminated via the light projecting out opening 112 of the reflective lamp shade 11, they will not become null light. The light beams S4, S5, S6 and S7 can be taken for comparison with the corresponding light beams shown in FIG. 1, by the fact that the present invention does not have impedance of the electric power source connector 93 as in the prior art, the light beams which may become null light will become effective light in the present invention; in view of this, all the light beams created by the light emitting element 12 can nearly all be refracted and reflected out of the light projecting out opening 112 of the reflective lamp shade 11, for sure, they can increase the brightness of illumination.

The light emitting element 12 shown in FIG. 2 is a light emitting diode, and the two through holes 114 of the reflective lamp shade 11 are provided on the closed top of the wall 111, the two conductors 121 of the light emitting element 12 (a light emitting diode for example) are extended upwards.

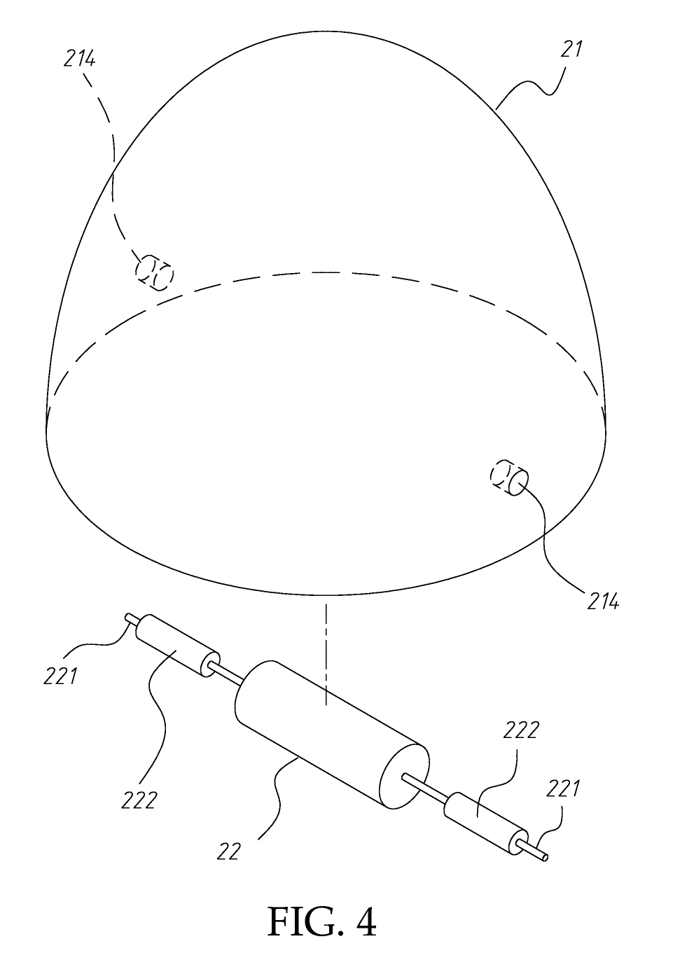

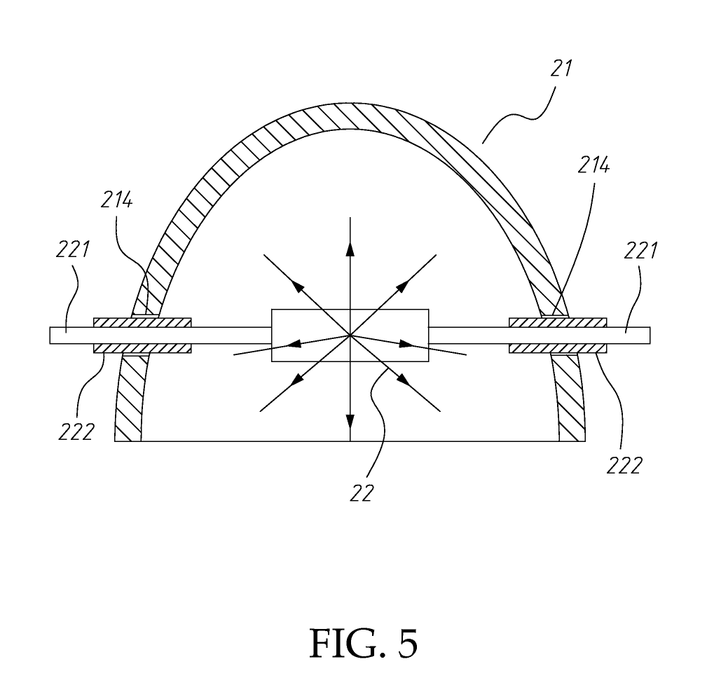

FIGS. 4 and 5 show a second embodiment of the illuminating unit with high efficiency of the present invention, the illuminating unit is also comprised mainly of a light emitting element 22 and a reflective lamp shade 21. The reflective lamp shade 21 is same as that of the first embodiment, but two through holes 214 are provided on the two lateral sides of a wall, two conductors 211 of the light emitting element 22 are extended toward the lateral directions, two insulation portions 222 are fixed in the two through holes 214 respectively in the mode as of xenon head lights.

As shown in FIG. 5, light beams emitted from the light emitting element 22 nearly can all directly get out of or refracted out of the light projecting out opening 112 of the reflective lamp shade 11 to increase the brightness of illumination.

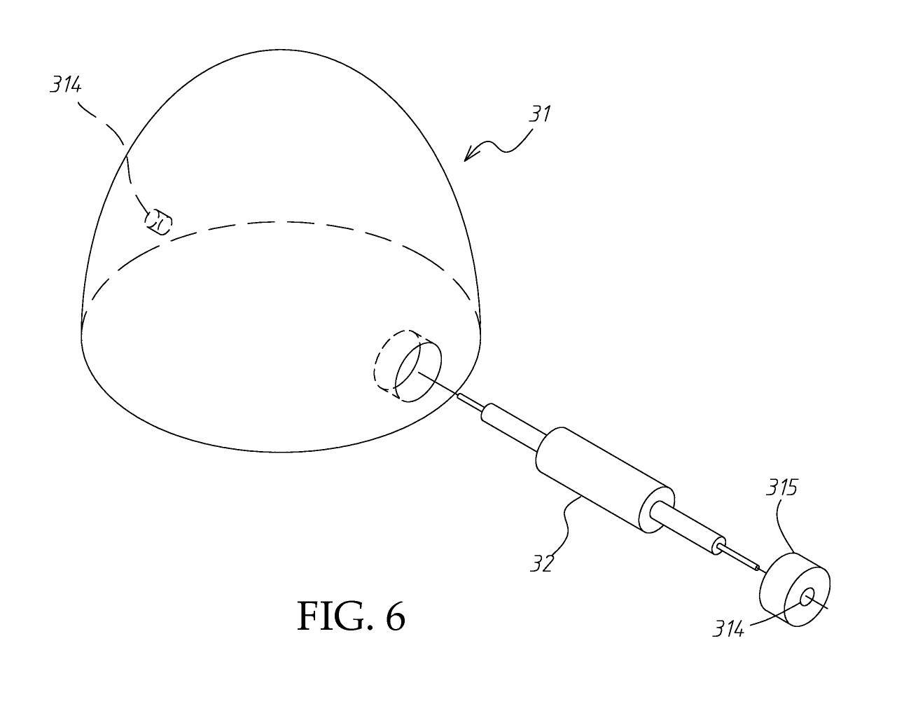

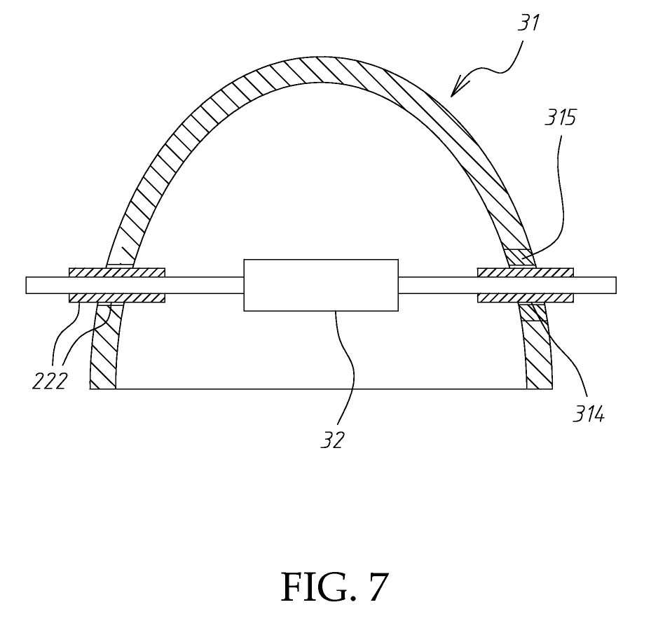

FIGS. 6 and 7 show a third embodiment of the present invention, the third embodiment basically is same as the second embodiment, and is comprised of a light emitting element 32 and a reflective lamp shade 31.

A through hole 314 on the reflective lamp shade 31 is encircled by a removable separating piece 315; the size of the separating piece 315 is larger than the largest size of the light emitting element 32. This design makes easier mounting of the light emitting element 32 in the reflective lamp shade 31.

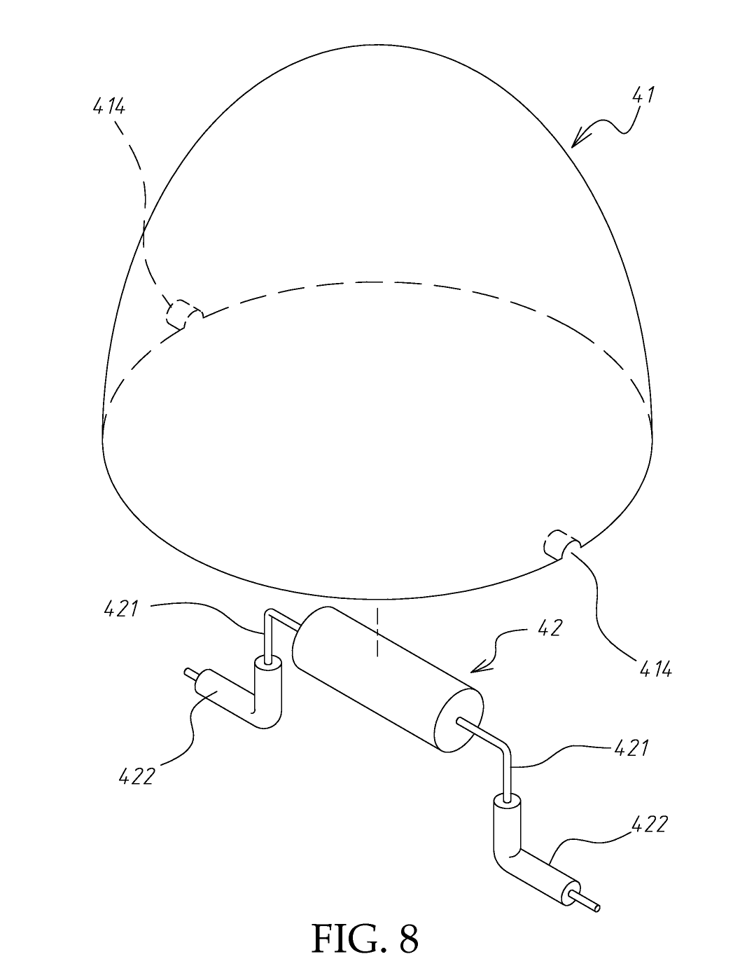

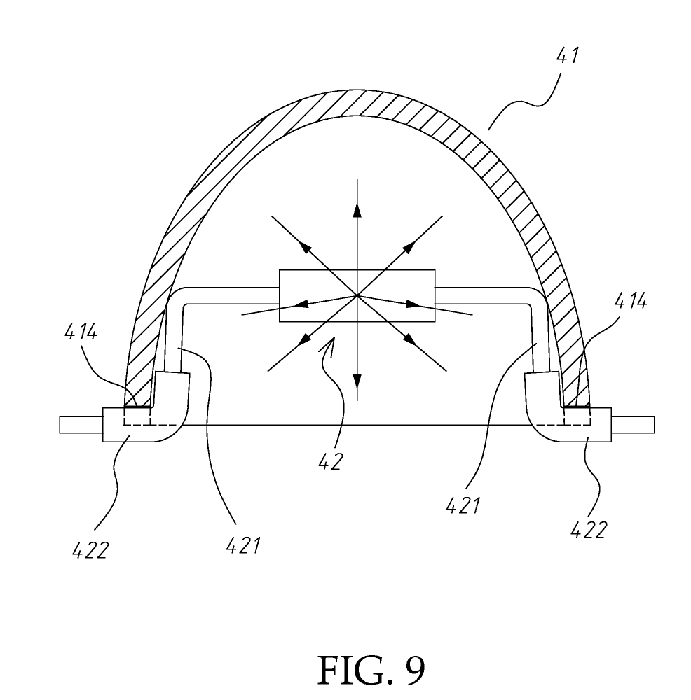

FIGS. 8 and 9 show a fourth embodiment of the illuminating unit with high efficiency of the present invention, the illuminating unit comprises a reflective lamp shade 41 and a light emitting element 42. The reflective lamp shade 41 is same as that of the second embodiment, but two through holes 414 are provided on the two bottom of a wall 111; two conductors 421 of the light emitting element 42 are bent to be in the shape of two cranks and have thereon insulation portions 422. The upper portions above the insulation portions 422 of the two bent conductors 421 are elastically abutted on the inner side of the hollow reflective lamp shade 41. This design makes easier mounting and change of the light emitting element 42.

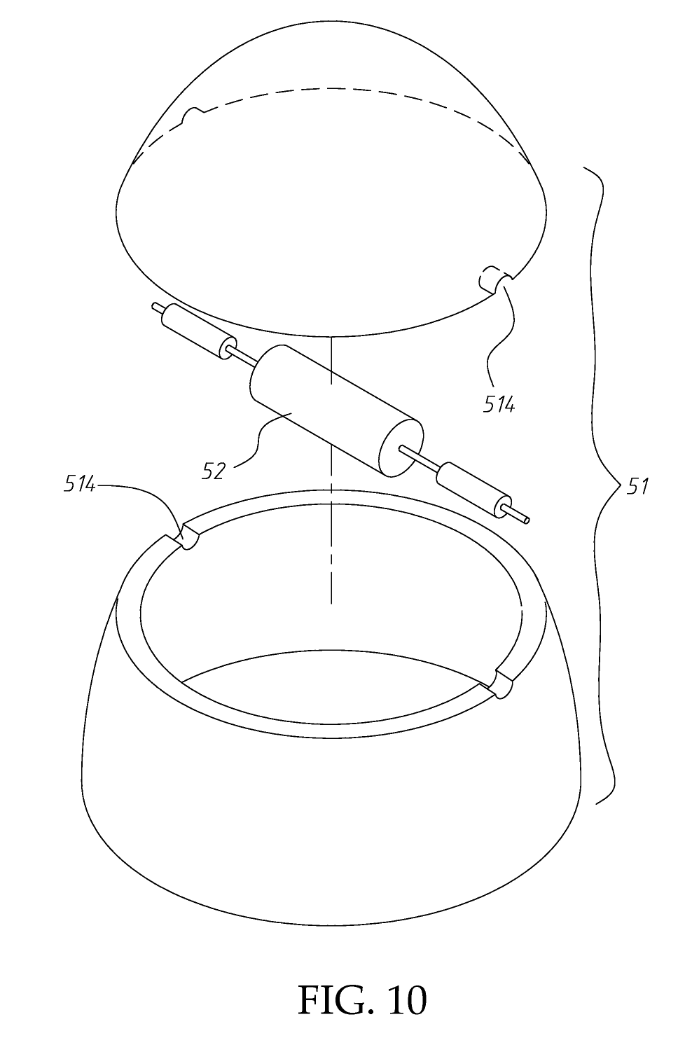

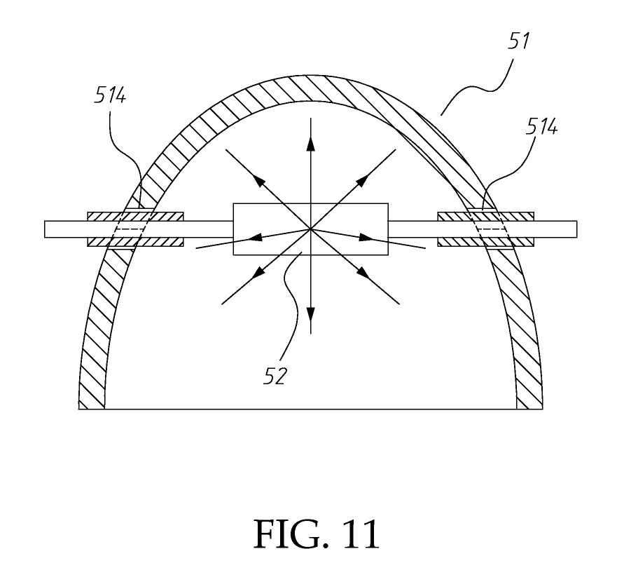

FIGS. 10 and 11 show a fifth embodiment of the illuminating unit with high efficiency of the present invention which comprises a reflective lamp shade 51 and a light emitting element 52, basically same as the second embodiment, but the reflective lamp shade 51 is separably assembled at a level where through holes 514 on it are located by using connectable flanges or screw threads.

Having thus described my invention, what I claim as new and desire to be secured by Letters Patent of the United States is:

1. An illuminating unit with high efficiency, said illuminating unit comprises:
a light emitting element having two elongate conductors of which part outer surface areas have insulation portions, said elongate conductors are connected with an electric power source to provide electricity for said light emitting element to enlighten; and
a reflective lamp shade, having a wall encircling a hollow space which forms a light projecting out opening and then extends upwards till a closed top, in order that an inner surface of said wall forms a complete arched reflecting surface, said wall is provided thereon at least with two through holes which each is only extended therethrough by one of said conductors of said light emitting element, and said insulation portions of said conductors are fixed in said through holes;
said light emitting element is placed in said reflective lamp shade; when light beams irradiate said reflective surfaces, they are refracted for several times and irradiate a district to be illuminated via said light projecting out opening of said reflective lamp shade.

2. The illuminating unit with high efficiency as in claim 1, wherein:
said insulation portions on said light emitting element are insulating sleeves.

3. The illuminating unit with high efficiency as in claim 1, wherein:
said insulation portions on said light emitting element are painted with insulation paint.

4. The illuminating unit with high efficiency as in claim 1, wherein:
said at least two through holes on said reflective lamp shade are provided on a closed top of said wall, said two conductors of said light emitting element are extended upwards.

5. The illuminating unit with high efficiency as in claim 1, wherein:
said at least two through holes on said reflective lamp shade are provided on two lateral sides of said wall, said two conductors of said light emitting element are extended toward two lateral directions.

6. The illuminating unit with high efficiency as in claim 5, wherein:
a through hole on said reflective lamp shade is encircled by a removable separating piece; size of said separating piece is larger than a largest size of said light emitting element.

7. The illuminating unit with high efficiency as in claim 5, wherein:
said two through holes of said reflective lamp shade are provided on a bottom of said wall, said two conductors of said light emitting element are bent to be in shape of two cranks and have thereon said insulation portion, upper portions above said insulation portions of said two bent conductors are elastically abutted on an inner side of the hollow reflective lamp shade.

8. The illuminating unit with high efficiency as in claim 5, wherein:
said reflective lamp shade is separably assembled at a level where said through holes on it are located.
